(19) United States
(12) Patent Application Publication
(10) Pub. No.: US 2007/0276726 A1
(43) Pub. Date: Nov. 29, 2007

(54) In-stream advertising message system

(76) Inventor: Keith DiMatteo, Charlestown, MA (US)

Correspondence Address: Mr. Keith DiMatteo, 267 Main Street, #2a, Charlestown, MA, 02129, US

(21) Appl. No.: 11/439,355

(22) Filed: May 23, 2006

(51) Int. Cl. G06Q 30/00; H04N 7/10; H04N 7/025

(52) U.S. Cl. 705/14; 725/32; 725/34

(57) ABSTRACT

The present invention is directed to a method and system for inserting advertising messages into digitally encoded audio and audio-visual content. Such methods are useful for enabling one to gain support for web-based media programs such as those that might be characterized as podcasts. Methods for cueing audio files are indicated so that different messages may be incorporated into the audio files according to different user profiles prior to delivery of media content to a user over the web.

### BACKGROUND OF THE INVENTION

The concepts of being able to insert advertisements and related messages into software products, web-browsers and telephone text messaging systems have been disclosed in a number of U.S. patents. For example in U.S. Pat. No. 7,003,478, “Advertising method using software products” by Choi describes a method to insert advertisements into at least a portion of a software program so that a message displays during the use of the program. White in U.S. Pat. No. 6,496,205 and U.S. Pat. No. 6,005,563 describes a user interface for controlling audio functions in a web browser. Binder in U.S. Pat. No. 6,513,052 teaches targeted advertising over global computer networks and Ehrlich in U.S. Pat. No. 6,546,427 teaches a streaming multimedia network with automatically switchable content sources. Selecting advertisements based upon development of a user profile is indicated by Binder in U.S. Pat. No. 6,513,052 “Targeted advertising over global computer networks.” Go extends the concept of advertisements of different types being broadcast via cellular phone connections as in U.S. Pat. No. 7,010,293 “Digital advertising method utilizing a cellular telephone display.” These references are incorporated herein by reference.

A recent development in electronic communications has been the ability to develop programs that include a selection of songs, sounds and commentary into an integrated package that is broadcast from a website to any listeners logged into that site. This can be played in real time or served up upon demand by the user. Such programs are often described as “podcasts”. A web developer may take on the role of disk jockey, commentator and producer. Podcasts which are often less than 30 minutes long may be downloaded and played on such peripheral devices as iPods made popular by Apple Computer Corp., personal computers or other digital devices providing audio output.

According to Wikipedia (http://en.wikipedia.org/wiki/Podcasting), the free on-line encyclopedia, podcasting is:
“the distribution of audio or video files, such as radio programs or music videos, over the Internet using either RSS or Atom syndication for listening on mobile devices and personal computers. The term podcast, like “radio”, can mean both the content and the method of delivery. Podcasters' websites also may offer direct download of their files, but the subscription feed of automatically delivered new content is what distinguishes a podcast from a simple download or real-time streaming. Usually, the podcast features one type of “show” with new episodes either sporadically or at planned intervals such as daily, weekly, etc. In addition to this, there are podcast networks that feature multiple shows on the same feed. Podcasting's essence is about creating content (audio or video) for an audience that wants to listen when they want, where they want, and how they want.”

### An entry in Wikipedia further explains that

“While the name was primarily associated with audio subscriptions in 2004, the RSS enclosure syndication technique had been used with video files since 2001, before portable video players were widely available. Atom, a recently developed web syndication format, supports rich media content by design, as does standard RSS 2.0 based upon XML 1.0 standards. In fact, any file with a URL, including still images and text, can be delivered via a web feed.”

### In none of the foregoing has there been taught a system or method how one might insert advertisements or audio commercial messages into a program or “show” such as a podcast.

### BRIEF SUMMARY OF THE INVENTION

The present invention is directed to a useful method and system for inserting messages such as advertisements, sponsor promotions or public service announcements into digitally encoded media content. The media may be audio only, audio and images, video or some combination of various media. As explained in detail below, the invention further reveals a method for and process of inserting targeted advertising information to a user as part of a playable or downloadable show or program.

The sponsorship messages typically but not exclusively are audio based advertisements which are selected from a given set of possible audio messages or ads. The selection process is based on available information about the user including any explicitly stated information (e.g., age, location) or information that may be implied (e.g., the users IP address, behavioral history, etc.). The selected messages are inserted into the requested content at pre-determined intervals. This process scans content files for cue-points of a specific audio frequency and duration then splices-in the ad(s) and re-renders the content file into a specified format. The user/viewer enters a website and selects a program to view and/or to listen to. When the selection is made, the content is delivered to the viewer/user along with any embedded messages.

The sequence would be that

### 1. A user clicks to download or stream an audio/media content file.

2. The request for content is handed off to the in-stream ad server which:
a. examines available user profile information
b. selects an appropriate sponsorship messages
c. scans the audio/media content file for cue points
d. inserts the sponsorship messages selected in step b into the audio/media content file
e. delivers the content audio/media file to the user

### The requested content including the system-selected advertisements are then served to the requesting user.

It is a further object of the invention that the digitally encoded audio content is in the form of a playable or downloadable podcast from a web server which could be in the format of MP3 files.

It is a further object of the invention that a system is provided for producing digital programs or shows that incorporates messages such as advertisements based upon silent cues and a means of selecting appropriate messages.

It is further an object of the invention that the method of inserting selected advertisements could also be applied to program content that had both audio and video components.

It is further an object of the invention that a system is described which will integrate the development of podcasts or short program segments with a means for delivering advertising messages on cue.

A further object of the invention is to describe an apparatus comprised of one or more networked computers that runs the embedded software needed to implement the development and production of podcasts having appropriately inserted messages tailored to particular users.

A further object of the invention is a practical device comprising an embedded data signal that has been inserted into an audio stream and can be extracted from said stream and replaced with an alternative signal having an audible message content.

The following detailed description is not to be taken in a limiting sense and the scope of the present invention is defined by the claims.

### BRIEF DESCRIPTION OF DRAWINGS

FIG. 1 is a flow diagram of the message/advertisement delivery aspect of the invention.

FIG. 2 is a diagram of the components of the over-all system for producing podcasts having tailored advertising messages incorporated therein.

### DETAILED DESCRIPTION OF THE INVENTION

The present invention is a system for producing digital programs or shows that incorporate messages such as advertisements that are cued in appropriate ways and the methods which enable this.

In the following detailed description, references are made to the accompanying drawings that illustrate specific embodiments in which the invention may be practiced. Programmatic and structural changes may be made to the embodiments without departing from the spirit and scope of the present invention.

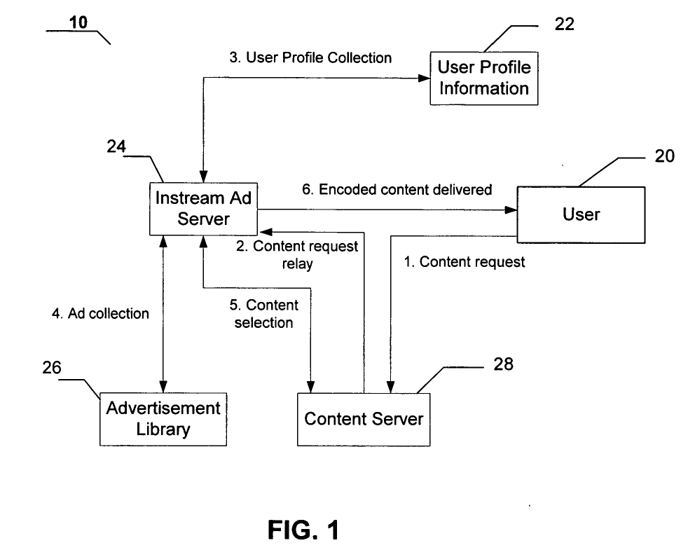

FIG. 1 describes the context of the in-stream ad server in relation to the users request for the content audio file, the given set of possible audio ads and the delivery of the content audio file.

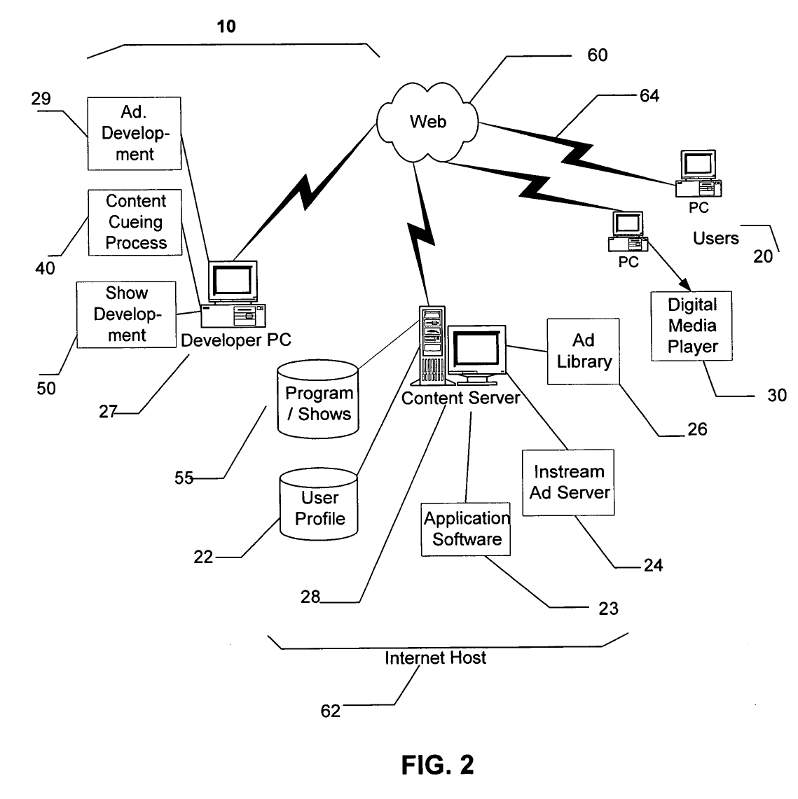

The system 10 interfaces with the user 20 who connects with a web site and selects a particular program or show. This is represented by Step 1, content request which is made to the Content Server 28 which in one embodiment is located with the internet host (62 of FIG. 2). The content server relays this request (Step 2) to the Instream Ad Server 24 along with user identifying information. In one embodiment the Ad Server receives input from a User Profile Information database 22 represented by Step 3, User Profile collection. Note that this is not a necessary step in other embodiments. It also receives input from an Advertisement Library 26 represented by Step 4, Ad collection. A matching algorithm is implemented that selects an appropriate sponsorship message based on user profile information (when such information is available). At approximately the same time the Instream Ad Server runs a program that scans the incoming (Step 5) user-selected audio content file (from among one or more options on the Content Server) for cue points and inserts the sponsorship messages selected above into the audio content file and re-renders it. This encoded content is then delivered back to the User 20 (Step 6)

FIG. 2 presents the components of the over-all system for producing podcasts and the like having tailored advertising messages incorporated therein. The system 10 is shown to the left of the figure; whereas the right side shows the users 20 who are in communication with the system via connections 64 to the world wide web 60 via wireless, land-line, cable connections or the like. The users 20 may view the program/show either directly on their personal computer or it may be captured for subsequent playing using a digital media player 30 that could display the content as MP3 files, MPEG, WMV, WAVE files or the like. In the simplest implementation a digital audio player would be used. However, in all instances it should be apparent that audio content could just as well be more complex data streams including audio-visual formats, video streams and the like.

In this particular embodiment, the Instream Ad Server 24, the Content Server 28, the User profile file 22 and the Program/show 55 are all resident on (embedded in) the equipment of the Internet Host 62. The Advertisement Library 26 may also reside on the same equipment although in the figure it is shown as being resident with the developer's equipment 27. The exact location of each component is not a principal aspect of the invention and other scenarios are considered within the scope of the present invention.

Shown in FIG. 2 but not in FIG. 1 are the additional components of the system 10; namely a Show development component 50 and a Content Cueing process 40, an Advertisement Message Development component 29 and Application software 23. The Show development component 50 presents the role of the show producer who not unlike a disk jockey (DJ) will select music and other sound clips and play them in a sequence usually with some introductory and summary remarks interspersed periodically. In the case of a radio broadcast DJ, commercial messages would be inserted periodically as well. The present invention teaches the process for inserting messages into the show based upon matching possible messages in the Advertisement library 26 with information gleaned from the User profile 22 such as interests based upon which program/show is selected, historical information that could be captured in the case of a repeat user (implied by the same IP (Internet protocol) address in some instances), especially if the user had entered personal information such as age, address, etc. as part of a registration or subscription process. Intelligent software is well known in the art for matching advertisements with user profiles and activity and will be an additional component of the present system.

For users 20 who make repeated connections to the web site, a computer Application program 23 resident on the Host 62 will take input from the Instream Ad Server 24, the Advertisement Library 26 and the User profile 22 and look for cue signals that were embedded in the show during the Content Cueing process 40 and finding such will replace that signal with an appropriate message, re-render the file and deliver it to the User 20 integrated with their selected program/show.

The application program 23 will take note of whether the User has recently accessed content and will rotate audio or audio-visual ads through audio content the same way rich media ads are rotated through web content. Every time a piece of audio content is requested from the web server, it will be delivered through this system to the user.

Advertisement Message Development component 29 is where commercial and other messages are developed which are then subsequently uploaded into the Advertisement Library 26 on one of the servers of the Internet Host 62.

The Content Cueing Process 40 is comprised of a method to produce a cue signal (may be audible or non-audible sound as long as it is pre-defined in the ad-insertion system) at selected points in the show. The cue signal may be any audio signature of a specific frequency and duration. The content creator will insert these cue signals during the development and editing process. They may be determined by the content creator and identified within the ad-insertion system. In the present preferred embodiment a 2 second long 3.58 MHz beep is specified. This can be accomplished by using a source such as a cell phone or similar high frequency tone generator placed near the microphone of the computer/recording system.

A range of durations and frequencies is equally functional. For example one might use tones in the normal range of hearing although the preferred embodiment would be higher frequency tones even as high as 4 MegaHz tone for 0.5-3 seconds.

In another embodiment, one might insert a cue signal/tone in post production using audio editing software. When the finished content is served, it is processed by this pattern recognition software that finds the tone, replaces it with an ad and creates a composite file for presentation to the user. Detecting the signal differences between music and speech would enable one to automatically insert messages when a detected transition points is detected.

This application is intended to cover any adaptation or variation of the present invention. It is intended that this invention be limited only by the claims and equivalents thereof.

I claim:

1. A method whereby a developer can produce digital programs/shows for presentation to users over a web server that flexibly allows the insertion of appropriate messages into pre-selected spots throughout the show comprised of a means of inserting audio signals and a means of detecting said signals and making changes to said show prior to presentation to user.

2. The method of claim 1 further comprised of a dynamically created user profile database that stores information associated with each user.

3. The method of claim 2 wherein such information gleaned from the user contains one or more of: interests based upon which program/show is selected, historical information implied by the same IP address, age, address, and registration and subscription details.

4. The method of claim 1 wherein said messages are stored on a database associated with an instream ad server.

5. The method of claim 1 wherein said digital programs/shows may be audio or a combination of audio and images.

6. The method of claim 5 wherein said images may be video images.

7. The method of claim 1 wherein said pre-selected spots are inserted at the discretion of the developer by using well defined sound bursts that are at frequencies at or above the range of human hearing and such that a detector can locate such sound bursts and trigger editing software to replace said bursts with a message.

8. The method of claim 7 wherein said message is a commercial advertisement comprised of one of: an audio file, audio-visual presentation, or video data stream.

9. The method of claim 4 wherein said ad server has intelligent software that selects the most appropriate message as a function of the user profile and activity.

10. The method of claim 1 wherein said pre-selected spots are determined post-production by pattern recognition software that locates transition points between music and voice only.

11. A system comprising:
a developer computer having audio recording and editing capability,
A means for inserting cueing audio signals into audio files,
A connection to a webpage hosted by an internet service provider,
An advertisement/message database,
one or more software programs for detecting cueing signals, selecting advertisements/messages from the database and replacing cueing audio signals with said advertisements/messages,
A means to re-render the audio files and present to a world wide web or Internet user for playing or downloading, and
A user interface allowing selection of audio files from a database associated with a content server.

12. The system of claim 11 wherein re-rendering the audio files produces a composite file in one or more standard formats.

13. The system of claim 12 wherein one such standard format is MP3.

14. The system of claim 11 wherein means for inserting cueing audio signals is comprised of a signal generator producing non-audible sounds in the range of a 0.5-4 MHz tone for a duration in the range of 0.5-4 seconds.

15. The system of claim 11 further comprised of an Instream Ad Server and an advertisement library database.

16. The system of claim 11 wherein said user interface is compatible with customary web browsers including Internet Explorer and Netscape.

17. The system of claim 11 wherein the downloadable form of the functions as an audio podcast from a web server.

18. The system of claim 11 further comprised of a user profile database comprised of information captured about each user.

19. An apparatus comprised of one or more networked computers that runs the software needed to implement the development and production of podcasts having appropriately inserted messages tailored to particular users and further comprised of an advertisement library, and instream ad server, a user profile database and a content server.

20. A device comprising an embedded data signal that has been inserted into an audio stream and can be extracted from said stream and replaced with an alternative signal having an audible message content and is further comprised of a means of producing and subsequently detecting cueing signals and further comprising a library of advertisements that can be matched with user profile information and activity of each particular user.
